(19) United States
(12) Patent Application Publication
(10) Pub. No.: US 2026/0189959 A1
(43) Pub. Date: Jul. 2, 2026

(54) FLEXIBLE QOE CONFIGURATION FOR QOE HANDLING

(71) Applicant: Telefonaktiebolaget LM Ericsson (publ), Stockholm (SE)

(72) Inventors: Luca LUNARDI, GENOVA (IT); Filip BARAC, HUDDINGE (SE); Cecilia EKLÖF, TÄBY (SE); Johan RUNE, LIDINGÖ (SE); Agne ÅBERG LARSSON, UPPSALA (SE); Vengatanathan KRISHNAMOORTHI, LINKÖPING (SE)

(73) Assignee: Telefonaktiebolaget LM Ericsson (publ), Stockholm (SE)

(21) Appl. No.: 19/127,123

(22) PCT Filed: Nov. 1, 2023
(86) PCT No.: PCT/SE2023/051099

§ 371 Date: May 4, 2025

Related U.S. Application Data
(60) Provisional application No. 63/422,368, filed on Nov. 3, 2022.

(51) Int. Cl. H04W 24/10; H04W 24/02

(52) U.S. Cl. CPC H04W 24/10; H04W 24/02

(57) ABSTRACT

A method is provided implemented in a user equipment (UE). The method includes receiving a flexible configuration for handling at least one of (i) a radio access network (RAN) visible quality of experience (RVQoE) measurement or a RVQoE report and (ii) a quality of experience (QoE) measurement or a QoE report that is not visible to the RAN. The flexible configuration includes at least one of a first indication for performing and/or reporting QoE measurements and/or RVQoE measurements, and a parameter to be adjusted based on a fulfillment of a condition. The method further includes handling the at least one of the RVQoE measurement, the RVQoE report, the QoE measurement visible to the RAN, and the QoE report that is not visible to RAN based on the first indication and/or on adjustment of the parameter responsive to the fulfillment of the condition.

### TECHNICAL FIELD

The present disclosure relates generally to communications, and more particularly to communication methods and related devices and nodes supporting wireless communications.

### BACKGROUND

Quality of Experience (QoE) measurements, also referred to as “application layer measurements”, have been specified for Long Term Evolution (LTE) and Universal Mobile Telecommunications System (UMTS) and are being specified for New Radio (NR) in the Third Generation Partnership Project (3GPP) release 17. The purpose of the application layer measurements is to measure the end user experience when using certain applications. Currently QoE measurements for streaming services and for Mobility Telephony Service for IP Multimedia Subsystem (MTSI) services are supported.

Approaches in LTE and UMTS are similar with the overall principles as follows. Quality of Experience Measurement Collection (QMC) enables configuration of application layer measurements in the user equipment (UE) and transmission of QoE measurement result files (commonly referred to as QoE reports) to the network by means of radio resource control (RRC) signaling. An application layer measurement configuration (also called QoE measurement configuration or QoE configuration) that the radio access network (RAN) receives from the operation and maintenance (OAM) system or the core network (CN) is encapsulated in a transparent container, which is forwarded to a UE in a downlink RRC message. An application layer measurement report (also called QoE report) that the UE Access Stratum (UE AS) or UE RRC layer receives from the UE's higher layer (application layer) is encapsulated in a transparent container and sent to network in an uplink RRC message. The RAN then forwards the QoE report to a Measurement Collector Entity (MCE).

In 3GPP release 17 a study item for “Study on NR QoE management and optimizations for diverse services” for NR has been approved and concluded. The purpose of the study item was to study solutions for QoE measurements in NR. QoE management in NR will not just collect the quality of experience parameters of streaming services but also consider the typical performance requirements of diverse services (e.g., augmented reality/virtual reality (AR/VR) and ultra-reliable low latency communications (URLLC)). Based on requirements of services, the NR study also included more adaptive QoE management schemes that enable network optimization to satisfy user experience for diverse services.

The configuration data related to QoE measurements (in standard specifications typically referred to as application layer measurements) includes of a service type indication, an indication of an area in which the measurements are to be performed (denoted area scope), an IP address of the entity the collected measurement results (e.g., the QoE reports) should be sent to (often referred to as a MCE, spelled out as Measurement Collector Entity or Measurement Collection Entity, but the entity may sometimes also be referred to as a Trace Collection Entity) and a set of instructions of which type of measurements that should be performed and details of how these measurements are to be performed. These instructions are intended for the application layer in the UE and are placed in a “container” which the network entities handling it, e.g., forwarding it to the UE, as well as the UE Access Stratum, cannot interpret and do not try to read. The currently specified service types are MTSI and streaming service (Dynamic Adaptive Streaming over HTTP (DASH)). An area scope is defined in terms of cells or network related areas. In UMTS, an area scope is defined as either a list of cells, a list of routing areas or a list of tracking areas. In LTE, an area scope is defined as either a list of cells or a list of tracking areas.

QoE, and in particular QoE configuration, includes two cases: management-based QoE configuration and signaling-based QoE configuration. In both cases the QoE configuration originates in the OAM system or some other administrational entity, e.g., dealing with customer satisfaction. All of these entities are in this document referred to as the OAM system (where the OAM system also contains further entities).

With management-based QoE (m-based QoE), the OAM system collects general QoE statistics from a certain area (which is configured as an area scope). The m-based QoE configuration is sent directly from the OAM system to the RAN nodes controlling cells that are within the area scope. Each RAN node then selects UEs that are within the area scope (and also fulfills any other relevant condition, such as supporting the concerned application/service type) and sends the m-based QoE configuration to these UEs.

With signaling-based QoE (s-based QoE), the OAM system collects QoE measurement results from a specific UE, e.g., because the user of the UE has filed a complaint. The OAM system sends the s-based QoE configuration to the home subscriber server (HSS) (in Evolved Packet System (EPS)/LTE) or unified data management (UDM) (in 5GS/NR), which forwards the QoE configuration to the UE's current core network node, e.g., an mobility management entity (MME) in EPS/LTE or an access and mobility management function (AMF) in 5G/NR. The CN then forwards the s-based QoE configuration to the RAN node that serves the concerned UE and the RAN forwards it to the UE.

Forwarded to the UE are the service type indication and the container with the measurement instructions. The UE is not aware of whether a received QoE configuration is m-based or s-based. In legacy systems, the QoE framework is integrated with the Trace functionality and a Trace ID is associated with each QoE configuration. In NR, the QoE functionality will be logically separated from the Trace functionality, but it will still partly reuse the Trace signaling mechanisms. In NR and LTE, a globally unique QoE reference (formed of the mobile county code (MCC), mobile network node (MNC), and QoE measurement collection ID (QMC ID), where the QMC ID is a string of 24 bits) will be associated with each QoE configuration. The QoE reference is included in the container with measurement instructions and also sent to the RAN (e.g., the gNodeB (gNB) in NR). For the communication between the gNB and the UE, the QoE reference is replaced by a shorter identifier denoted as measConfigAppLayerId, which is locally unique within a UE (e.g., there is a one-to-one mapping between a measConfigAppLayerId and a QoE reference for each QoE configuration provided to a UE. The measConfigAppLayerId is stored in the UE Access Stratum and forwarded in an Attention (AT) Command (which is the type of instructions used in the communication between the UE's modem part and the UE's application layer) together with the service type indication and the container with the measurement instructions.

Reports with collected QoE measurement results (QoE reports) are sent from the UE application layer to the UE Access Stratum, which forwards them to the RAN, which forwards them to the MCE. These QoE measurement results are placed in a “container”, which is uninterpretable for the UE Access Stratum and the RAN. QoE reporting can be configured to be periodic or only sent at the end of an application session. Furthermore, the RAN can instruct the UE to pause QoE reporting, e.g., in case the cell/gNB is in a state of overload.

The RAN is not aware of when an application session with an associated QoE measurement session is ongoing, and the UE Access Stratum is also not automatically aware of this. To alleviate this session start/stop indications can be introduced, which will be sent from the application layer in the UE to the UE Access Stratum (AS) and from the UE AS to the RAN. A session stop indication may be implicit in the form of a QoE report sent when the application session and the associated QoE measurement session are concluded.

The RAN may decide to release a QoE configuration in a UE at any time, as an implementation-based decision. Typically, it may be done when the UE has moved outside an area configured for the QoE measurements, commonly referred to as the area scope.

One opportunity provided by legacy approaches is also to be able to keep the QoE measurement for the whole session, even during a handover situation. It is also possible to let the UE continue with the QoE measurements on an ongoing application session until the application session ends, even if the UE in the meantime moves out of the configured area scope.

An extension of the QoE framework, which has been studied for 3GPP release 17 and which is currently specified in 3GPP is the concept of RAN visible QoE (RVQoE). The regular QoE reports are intended for the MCE, which is an entity outside the RAN, e.g., a part of the OAM system, and the RAN cannot read the QoE reports (at least not according to specification, although gNB/Evolved Node B (eNB) implementations are not prevented from doing so). In contrast, reported RVQoE metrics are intended for the RAN and are delivered to the RAN in a format that the RAN understands. The RVQoE metrics are derived from the regular QoE metrics, collected and compiled in reports by the UE application layer and delivered to the RAN, so that the RAN may use the reports for various types of optimizations. As an example, when the RAN receives RVQoE reports during an ongoing application session, the RAN can perform adaptive actions to impact the QoE of the concerned application session while the application session is ongoing, such as change various parameters related to the scheduling of the UE and the data flows related to the application session.

There currently exist certain challenge(s). Currently, QoE/RVQoE measurements configuration may lack flexibility.

### SUMMARY

Certain aspects of the disclosure and their embodiments may provide solutions to these or other challenges.

The present disclosure provides operations that may enable flexibility in the setup of QoE/RVQoE measurements or the reporting of QoE/RVQUE measurements. The operations may consider different resource constraints at the UE related to measurement, storage, and transmit capability, and also may consider various scenarios that the UE may be involved in.

Some embodiments of the present disclosure introduce a flexible configuration to alter collection and reporting of QoE and/or RVQoE measurements by applying conditions to parts or aspects of QoE/RVQoE configuration.

Certain embodiments may provide one or more of the following technical advantage(s). An advantage of some embodiments may include that based on the inclusion of a flexible configuration, the method may provide unique QoE measurements/RAN visible QoE (RVQoE) measurements configuration/report that can consider different constraints at the UE side (e.g., its ability/processing power/memory/energy consumption that the UE can have when it is in a certain RRC state or in a certain power saving mode). Constraints at the RAN side can also be considered, e.g., whether a different level of handling for QoE measurements/RVQoE measurements is allowed in case of energy saving actions at RAN.

A further technical advantage may include that based on inclusion of the flexible configuration, some embodiments may allow for the analysis of the application-level performance/QoE when the UE is cycling through different RRC states. Thus allowing the RAN and the core network (through RVQoE reports or legacy QoE reports) to fine-tune network parameters that trigger the different RRC states and improve end-user QoE, without having to explicitly update the QoE/RVQOE configuration, which would require sending a new configuration to the UE.

Some embodiments of the present disclosure include a method implemented in a UE. The method includes receiving a flexible configuration for handling at least one of (i) a RVQUE measurement or a RVQoE report and (ii) a QoE measurement or a QoE report that is not visible to the RAN. The flexible configuration includes a parameter to be adjusted based on a fulfillment of a condition. The method further includes handling the at least one of the RVQoE measurement, the RVQoE report, the QoE measurement that is not visible to the RAN, and the QoE report that is not visible to RAN based on adjustment of the parameter responsive to the fulfillment of the condition.

Some embodiments of the present disclosure include a method implemented in a network node. The method includes receiving or determining a flexible configuration for handling at least one of (i) a RVQoE measurement or a RVQUE report and (ii) a QoE measurement or a QoE report that is not visible to the RAN. The flexible configuration includes a parameter to be adjusted based on a fulfillment of a condition. The method further includes sending the flexible configuration towards a UE to be used by the UE to handle the at least one of the RVQoE measurement, the RVQoE report, the QoE measurement that is not visible to the RAN, and the QoE report that is not visible to RAN based on adjustment of the parameter responsive to the fulfillment of the condition.

Some embodiments of the present disclosure include a UE configured to communicate with a network node. The UE includes a radio interface and processing circuitry configured to receive a flexible configuration for handling at least one of (i) a RVQoE measurement or a RVQUE report and (ii) a QoE measurement or a QoE report that is not visible to the RAN. The flexible configuration includes a parameter to be adjusted based on a fulfillment of a condition. The radio interface and processing circuitry is also configured to handle the at least one of the RVQUE measurement, the RVQoE report, the QoE measurement that is not visible to the RAN, and the QoE report that is not visible to RAN based on adjustment of the parameter responsive to the fulfillment of the condition.

Some embodiments of the present disclosure include a method implemented by a host operating in a communication system that further includes a network node and a UE. The method includes providing user data for the UE; and initiating a transmission carrying the user data to the UE via a cellular network comprising the network node. The UE performs the following operations to receive the user data from the host: receiving a flexible configuration for handling at least one of (i) a RVQoE measurement or a RVQoE report and (ii) a QoE measurement or a QoE report that is not visible to the RAN. The flexible configuration includes a parameter to be adjusted based on a fulfillment of a condition. The method further includes handling the at least one of the RVQE measurement, the RVQoE report, the QoE measurement that is not visible to the RAN, and the QoE report that is not visible to RAN based on adjustment of the parameter responsive to the fulfillment of the condition.

Some embodiments of the present disclosure include a host configured to operate in a communication system to provide over-the-top, OTT, service. The host includes processing circuitry configured to provide user data; and a network interface configured to initiate transmission of the user data to a cellular network for transmission to a UE. The UE comprises a communication interface and processing circuitry configured to receive the user data from the host. Operations include receive a flexible configuration for handling at least one of (i) a RVQUE measurement or a RVQoE report and (ii) a QoE measurement or a QoE report that is not visible to the RAN. The flexible configuration includes a parameter to be adjusted based on a fulfillment of a condition. The operations further includes to handle the at least one of the RVQOE measurement, the RVQoE report, the QoE measurement that is not visible to the RAN, and the QoE report that is not visible to RAN based on adjustment of the parameter responsive to the fulfillment of the condition.

Some embodiments of the present disclosure include a network node configured to communicate with a plurality of UEs. The network node includes processing circuitry configured to receive or determine a flexible configuration for handling at least one of (i) a RVQUE measurement or a RVQoE report and (ii) a QoE measurement or a QoE report that is not visible to the RAN. The flexible configuration includes a parameter to be adjusted based on a fulfillment of a condition. The processing circuitry is also configured to send the flexible configuration towards a UE to be used by the UE to handle the at least one of the RVQoE measurement, the RVQoE report, the QoE measurement that is not visible to the RAN, and the QoE report that is not visible to RAN based on adjustment of the parameter responsive to the fulfillment of the condition.

Some embodiments of the present disclosure include a method implemented by a host configured to operate in a communication system that further includes a network node and a plurality of UEs. The method includes providing user data for the UEs; and initiating transmissions carrying the user data to the UEs via a cellular network including the network node. The method further includes the network node performing the following operations to transmit the user data from the host to the UEs: receiving or determining a flexible configuration for handling at least one of (i) a RVQoE measurement or a RVQoE report and (ii) a QoE measurement or a QoE report that is not visible to the RAN. The flexible configuration includes a parameter to be adjusted based on a fulfillment of a condition. The network node also sends the flexible configuration towards a user equipment, UE, to be used by the UE to handle the at least one of the RVQoE measurement, the RVQoE report, the QoE measurement that is not visible to the RAN, and the QoE report that is not visible to RAN based on adjustment of the parameter responsive to the fulfillment of the condition.

Some embodiments of the present disclosure include a host configured to operate in a communication system to provide an OTT service. The host includes processing circuitry configured to provide user data; and a network interface configured to initiate transmissions of the user data to a network node in a cellular network for transmission to UEs. The network node includes a communication interface and processing circuitry, the processing circuitry of the network node configured to receive or determine a flexible configuration for handling at least one of (i) a RVQoE measurement or a RVQUE report and (ii) a QoE measurement or a QoE report that is not visible to the RAN. The flexible configuration includes a parameter to be adjusted based on a fulfillment of a condition. The processing circuitry of the network node is also configured to send the flexible configuration towards a user equipment, UE, to be used by the UE to handle the at least one of the RVQoE measurement, the RVQUE report, the QoE measurement that is not visible to the RAN, and the QoE report that is not visible to RAN based on adjustment of the parameter responsive to the fulfillment of the condition.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a flow chart illustrating operations of a user equipment (UE) according to some embodiments;

FIG. 2 is a flow chart illustrating operations of a network node according to some embodiments;

FIG. 3 is a block diagram of a communication system in accordance with some embodiments;

FIG. 4 is a block diagram of a user equipment in accordance with some embodiments;

FIG. 5 is a block diagram of a network node in accordance with some embodiments;

FIG. 6 is a block diagram of a host, which may be an embodiment of the host of FIG. 3, in accordance with some embodiments;

FIG. 7 is a block diagram of a virtualization environment in accordance with some embodiments; and

FIG. 8 shows a communication diagram of a host communicating via a network node with a user equipment over a partially wireless connection in accordance with some embodiments.

### DETAILED DESCRIPTION

Some of the embodiments contemplated herein will now be described more fully with reference to the accompanying drawings. Embodiments are provided by way of example to convey the scope of the subject matter to those skilled in the art, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

Currently, QoE/RVQUE measurements configuration may lack flexibility. Some approaches have fixed parameters according to which the measurements are conducted until the measurement configuration is released. This framework may not consider the constraints the UE may have when performing QoE measurements/RVQoE measurements or different scenarios that the UE may find itself in. For a UE in RRC_CONNECTED state, for instance, the power consumption is higher compared to the same UE in RRC_INACTIVE state or RRC_IDLE state. The difference in power consumption between the states is achieved by placing different components, e.g., memory, chipset, at different states which affects both the availability and accessibility of these resources. This different level of resource availability is not considered in QoE/RVQoE handling. Similarly, the memory allocated in the UE may be different in the different RRC states. Moreover, performing QoE/RVQUE measurements and reporting QoE/RVQUE measurements in energy-saving mode can be seen as a task to be performed at a lower priority compared to other tasks in the UE. On some occasions, e.g., for data delivered to a UE via Multicast Service or Broadcast Service, the UE may be configured to perform QoE/RVQUE measurements not only in RRC_CONNECTED (e.g., when in a RRC state where the highest processing power is available), but also in other RRC state which are not as efficient in terms of internal UE resources (processing power, memory, allowed energy consumption). On the other hand, it may be preferred that the measurement configuration is adjusted during certain network events, which, as of today, may require an explicit modification of measurement configuration. There is, however, a lack of flexibility in the mechanism for measurement configuration which would make it possible to adjust measurements to different scenarios and the UE constraints with respect to QoE/RVQUE handling. In addition to not considering the described limitation at the UE, the current framework also may be limited with respect to constraints at the RAN.

As previously indicated, currently, QoE/RVQoE measurements configuration has fixed parameters according to which the measurements are conducted until the measurement configuration is released. This framework may not consider the constraints the UE may have when performing QoE measurements/RVQoE measurements or different scenarios that the UE may find itself in.

The present disclosure provides operations that may enable flexibility in the setup of QoE/RVQoE measurements or the reporting of QoE/RVQUE measurements. The operations may consider different resource constraints at the UE related to measurement, storage, and transmit capability, and also may consider various scenarios that the UE may be involved in.

As used herein, the term “split RAN entities” (or “split gNB entities” or “split eNB entities”) refers to Central Unit Control Plane (CU-CP), Distributed Unit (DU) and Central Unit User Plane (CU-UP), unless stated otherwise.

As used herein, the term “RAN node” is used to denote (depending on the context), a gNB, eNB, gNB-CU, gNB-CU-CP, eNB-CU, eNB-CU-CP, Integrated Access and Backhaul (IAB)-donor, IAB-donor-CU, IAB-donor-CU-CP, gNB-CU-UP, eNB-CU-UP, IAB-donor-CU-UP, gNB-DU, IAB-donor-DU, or eNB-DU.

As used herein, a network node can be a RAN node, an OAM, a Core Network node, an OAM, a Service Management and Orchestration (SMO), a Network Management System (NMS), a Non-Real Time RAN Intelligent Controller (Non-RT RIC), a Real-Time RAN Intelligent Controller (RT-RIC), a gNB, eNB, en-gNB (which is a gNB acting as a second node in an EN-DC scenario, e.g., in a DC scenario with an eNB as the master node and a gNB as the secondary node), next generation eNB (ng-eNB), gNB-CU, gNB-CU-CP, gNB-CU-UP, eNB-CU, eNB-CU-CP, eNB-CU-UP, IAB-node, IAB-donor DU, IAB-donor-CU, IAB-DU, IAB-MT, open (O)-CU, O-CU-CP, O-CU-UP, open (O)-DU, O-RU, O-eNB, a Cloud-based network function, a Cloud-based centralized training node.

The terms “RRC state transition”, “state transition” and “transition” are used herein interchangeably.

As used herein, the term QoE configuration refers to any configuration parameters that impact or control the configured entity(entities), or behavior related to application layer measurements, e.g., QoE measurements, in a UE. A QoE configuration contains different configuration parameters for a UE, that is, when the configured entity is a UE, and for a RAN node, e.g., a gNB or an eNB, e.g., when the configured entity is a RAN node. The QoE configuration for a UE comprises at least the parameters in a MeasConfigAppLayer-r17 IE (with the possible exception of the parameters for RVQUE (see below)). The QoE configuration for a RAN node comprises the parameters related to QoE measurement and QoE measurement reporting the RAN node receives from the OAM system (for configuration of management-based QoE measurements) or the parameters related to QoE measurement and QoE measurement reporting the RAN node receives from the CN (e.g., an AMF or an MME) (for configuration of signaling-based QoE measurements).

An RVQoE configuration, e.g., including the RVQOE related parameters in a MeasConfigAppLayer-r17 IE may be seen as an integral part of the QoE configuration or as a separate configuration associated with the QoE configuration (and thus tied to the QoE configuration).

Some embodiments are directed to a method performed by a network node.

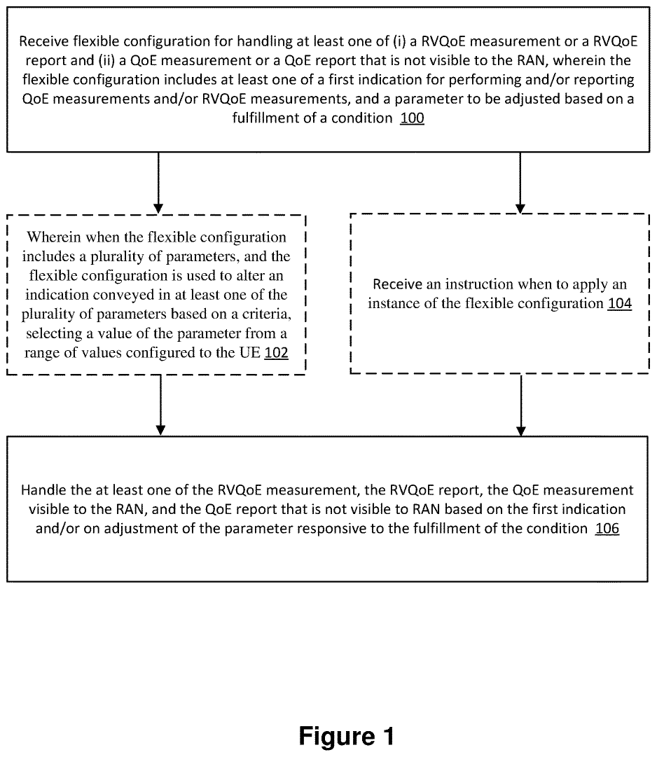

FIG. 1 is a flow chart illustrating operations of a UE according to some embodiments. As illustrated in FIG. 1, a method performed by a UE provided, the method includes receiving (100) a flexible configuration for handling at least one of (i) a RVQoE measurement or a RVQUE report and (ii) a QoE measurement or a QoE report that is not visible to the RAN. The flexible configuration includes a parameter to be adjusted based on a fulfillment of a condition. The method further includes handling (106) the at least one of the RVQUE measurement, the RVQoE report, the QoE measurement that is not visible to the RAN, and the QoE report that is not visible to RAN based on adjustment of the parameter responsive to the fulfillment of the condition.

For QoE measurements transparent to RAN, a RAN node can receive from another network node (an OAM node/function or a CN node, or another RAN node) a flexible configuration. In the example embodiment illustrated in FIG. 1, the receiving (100) the flexible configuration is received in at least one of (i) a QoE measurement job, (ii) a QoE measurement collection configuration received by a network node, (iii) a RVQE measurement configuration received by a network node, (iv) information associated to a QoE measurement collection configuration received by a network node, and (vi) information associated to a RVQOE measurement collection configuration received by a network node.

As used herein, the term “flexible configuration” refers to parameters in the measurement configuration (e.g., a sampling periodicity, reporting periodicity etc.) that are not constant, but rather depend on the fulfillment of certain conditions. In an example embodiment, a parameter includes at least one of a sampling periodicity, a reporting periodicity, a number or samples or values of a metric in the RVQoE or QoE report, a metric to be measured, and a format of a measured metric.

A condition can include, e.g., RRC state of the UE, mobility state of the UE, the UE velocity/speed, a UE related energy score, a network energy efficiency score, a network energy/power saving level, a network energy/power consumption level, the fulfillment of certain levels/thresholds (or range of values) for one or more reported QoE/RVQoE metrics, etc. In an example embodiment, a condition includes at least one of (i) a radio resource control, RRC, state of the UE, (ii) a mobility state of the UE, (iii) a velocity and/or speed of the UE, (iv) a UE related energy score, (v) a network energy efficiency score, (vi) a network energy and/or power saving level, (vii) a network energy and/or power consumption level, and (viii) a satisfaction of at least one value of a level or a threshold for at least one reported QoE metric or for at least one reported RVQoE metric or for at least one reported RVQoE value.

A flexible configuration can refer only to RAN Visible QoE (RVQoE) or only to QoE (non-visible to RAN) or to both RVQOE and QoE. In an example embodiment, the flexible configuration includes at least one of a configuration for a RVQoE and a configuration for a QoE that is not visible to the RAN.

A flexible configuration includes of indications (e.g., a list of values), to be used by a UE for determining the type and properties of QoE measurements (or RVQoE measurements) to be performed, and/or the amount (e.g., the periodicity) of QoE/RVQoE reports pertaining to the flexible measurements. In an example embodiment, the flexible configuration includes an indication to be used by the UE to determine a type and property of the QoE measurement to be performed, and/or an amount of the QoE report of the QoE measurement, and/or the RVQUE measurement to be performed, and/or an amount of the RVQUE report of the RVQOE measurement.

The flexible configuration can be included in a QoE measurement job, and/or as part of a QoE Measurement Collection (QMC) configuration sent to the RAN node, and/or as information associated to a QMC configuration and signaled separately to the RAN. The flexible configuration that is signaled in a QoE Measurement Collection (QMC) configuration, can be signaled outside a container transparent to RAN, or within a container transparent to RAN (e.g., as part of a Container for Application Layer Measurement Configuration). In an example embodiment, a method performed by a user equipment includes wherein the flexible configuration that is received in at least one of the QoE measurement collection configuration and/or for at least one of the RVQoE measurement collection configuration sent by a network node, and/or the information associated to a QoE measurement collection configuration and/or the information associated to a RVQoE measurement collection configuration, is outside a container transparent to the RAN or within a container transparent to the RAN.

For the RAN visible QoE (RVQoE) measurements, a RAN node can receive flexible configuration from another network node, in the same way as for QoE measurements transparent to RAN, but also determines at least part of flexible configuration by itself.

When flexible configuration is not used, or when its use is deactivated, a UE shall perform all the QoE/RVQOE measurements as indicated in the list of QoE/RVQDE metrics included in the QoE/RVQoE configuration. In an example embodiment, a method performed by a user equipment includes wherein when the flexible configuration is not used or is deactivated, the UE performs the QoE measurement as indicated in a list of QoE metrics included in a QoE configuration and/or as indicated in the list of RVQoE metrics included in a RVQoE configuration.

If a periodicity is configured for the reporting, that periodicity shall be respected. In an example embodiment, the flexible configuration includes a periodicity for the RVQoE or QoE report, the handling (operation 106 in FIG. 1) is performed at the periodicity. In another example embodiment, the QoE configuration includes a periodicity for the QoE report, the UE handles the QoE measurement or the QoE report of a QoE measurement at the periodicity.

Alternatively, the flexible QoE/RVQoE configuration parameters may define a default QoE configuration and/or a default RVQUE configuration, where the default QoE/RVQUE configuration is applied when the flexible QoE/RVQoE configuration parameter(s) otherwise is unused or deactivated. In an example embodiment, the flexible configuration includes a default configuration and the default configuration is applied when the flexible configuration is unused or deactivated.

In one option, flexible configuration can be used to alter (temporarily or not) the indications conveyed in other QoE/RVQE configuration parameters (e.g., which QoE metrics or RVQoE metrics should be measured, or the periodicity in the reporting), based on certain criteria (e.g., the current RRC state of a UE, the fact that energy saving actions are ongoing at a RAN node, mobility, UE location, energy status (e.g., battery charge level or remaining battery time), energy source (e.g., battery (optionally different battery categories depending on the battery capacity), power cord/power grid, solar cells, energy harvesting, etc.). In an example embodiment, the flexible configuration includes a plurality of parameters, and the flexible configuration is used to alter an indication conveyed in at least one of the plurality of parameters based on a criteria.

In one variant, the UE chooses itself a value of a configuration parameter from the range of values configured to the UE. An example embodiment illustrated in FIG. 1 includes selecting (102) a value of the parameter from a range of values configured to the UE. In another variant, the UE is explicitly instructed when to apply which instance of the flexible configuration. An example embodiment illustrated in Figure includes receiving (108) an instruction when to apply an instance of the flexible configuration.

A flexible QoE or RVQoE configuration may comprise that when a certain condition is fulfilled, the configured UE may be allowed to choose in a range of values characterizing a certain configuration property, e.g., choose the measurement/sampling periodicity as long as it is no longer than a configured maximum periodicity, e.g., MaxMeasurementPeriodicity, or choose the reporting periodicity as it is no longer than a configured maximum periodicity, e.g., MaxReportingPeriodicity.

A UE may be allowed to choose a range of granularities of reporting conditions in accordance with a flexible QoE/RVQoE configuration. For instance, a condition for RVQUE reporting may be that a certain RVQoE metric, e.g., RVQoE metric X, has changed more than “X” since the last time the metric was reported. Then a flexible RVQUE configuration may e.g., comprise that when a certain condition is fulfilled, e.g., that the UE is in an energy saving mode, the UE may select “X” as long as it is no greater than a maximum value “Y”.

A flexible QoE/RVQoE configuration may have several “sections” where the UE applies a specific section when an associated condition is fulfilled (such as the RRC state or the type of energy source). Such sections may be mutually exclusive, or each section may have its applicability evaluated independently, such that zero, one or multiple sections may be applied simultaneously. The same concept may be used for RVQoE configurations.

In another case, flexible configuration can explicitly indicate a certain RRC state or a list of RRC states to which the associated QoE/RVQoE configuration applies to/does not apply to.

In another case, flexible configuration can implicitly or explicitly apply to a specific RRC state or to a specific list of RRC states.

In another case, flexible configuration may indicate that a UE may pause certain measurements or reporting when certain condition(s) is/are fulfilled. An example embodiment includes pausing or stopping at least one of a RVQoE measurement, a QoE measurement, the RVQoE report, or the QoE report when the condition is fulfilled.

In another case, flexible configuration can explicitly or implicitly indicate certain UE-related energy/power saving state(s) or certain UE-related energy/power level(s) to which an associated QoE configuration applies to/does not apply to.

In another case, flexible configuration can explicitly or implicitly apply to certain UE-related energy/power saving state(s) or to certain UE-related energy/power level(s).

In another case, flexible configuration can explicitly or implicitly indicate certain RAN-related energy/power saving state(s) or RAN-related energy/power efficiency states/scores to which the associated QoE/RVQoE configuration applies to/does not apply to.

A RAN node can determine values of flexible configuration when certain conditions apply. For instance: when Uu is in overload, when processing capability or radio/transport resources at RAN are limited, when energy saving actions are ongoing (at different granularity levels: for a cell, for a reference signal beam, for the entire node).

The flexible configuration can contain the instruction about when the flexible configuration is applied and specify exit conditions for when flexible QoE configuration stops being applicable. In an example embodiment, the flexible configuration includes an instruction or a condition about when the flexible configuration is applied and/or an instruction or a condition for when the flexible configuration stops being applicable.

In one example, in case a QoE/RVQoE configuration is (by default) targeting UEs in RRC_CONNECTED state, a flexible configuration can be used to indicate that the same QoE/RVQOE configuration is also applicable for UEs in another RRC state (e.g., in RRC_INACTIVE state) or in all RRC states.

In another example, the QoE/RVQoE configuration is by default targeting UEs in all RRC states, and flexible configuration can be used to indicate to the UE that it is allowed to alter one or more QoE/RVQUE configuration information when the RRC state is changed. This indication can be generic, e.g., without indicating explicitly from which RRC state to which RRC state, or explicitly, indicating that alteration can apply when transitioning from a “from RRC state” and to a “to RRC state”. Examples of alterations can be the use a different reporting periodicity or measurement periodicity or avoiding the reporting of certain RVQoE metrics compared to the (default) QoE/RVQoE configuration information.

In another example, a flexible configuration can be used by a RAN node to indicate that QoE/RVQoE reporting is paused due to ongoing network energy saving actions.

In another example, flexible configuration can be used by a RAN node to indicate that QoE/RVQoE configuration is valid only when UE is using Multicast Service or only when using Broadcast Service. Or, vice versa, to indicate that QoE/RVQoE configuration is not valid when UE is using Multicast Service or when using Broadcast Service. Or in another variant, flexible configuration can be used to indicate that, when one of Multicast Service or Broadcast Service is used for the delivery of application session's data, the UE should also measure additional QoE/RVQoE metrics (e.g., as included in a separate QoE configuration for MBS).

In a flexible QoE configuration, or in a flexible RVQoE configuration, the UE may be instructed to collect/measure certain QoE or RVQUE metrics only in certain RRC states.

In a flexible QoE configuration, or in a flexible RVQoE configuration, the UE may be instructed to collect/measure certain QoE or RVQUE metrics, or to not collect/certain QoE or RVQUE metrics, only when certain event(s) occur or when certain condition(s) is(are) fulfilled. A list of possible such events and conditions (together referred to herein as “conditions”) can be found further below.

In other examples, the flexible configuration parameters may apply when one or more of the following is fulfilled:
When the UE is in a certain RRC state.
When the UE is receiving data via multimedia broadcast service (MBS).
When the UE is receiving data via MBS and is in a certain RRC state.
When the UE is in a certain mobility state (high mobility, low mobility).
When the UE is connected to a certain type of cell, e.g., high-speed data network cell.
When the UE is about to undergo, is undergoing, or has just undergone a handover, secondary node (SN) change, master node (MN) change or a switch from dual to single connectivity.
When the UE is in dual connectivity (DC).
When a DC leg is added.
When a DC leg is removed.
When a secondary cell group (SCG) is deactivated.
When a SCG is activated.
When the UE is in DC mode and its MN and SN are about to undergo, is undergoing, or have just undergone a role switch (e.g., the former SN became the new MN and the former MN became the new SN).
When the UE is in RRC_IDLE or RRC_INACTIVE state and is about to undergo, or is undergoing, or has just undergone a cell reselection to a new cell.
When the UE is about to undergo, is undergoing or has just undergone a transition from RRC_INACTIVE or RRC_IDLE state to RRC_CONNECTED state.
When the UE is about to undergo, is undergoing or has just undergone a transition from RRC_CONNECTED state to RRC_INACTIVE or RRC_IDLE state.
When the UE is about to undergo, is undergoing or has just undergone a transition from RRC_INACTIVE state to RRC_CONNECTED state.
When the UE is about to undergo, is undergoing or has just undergone a transition from RRC_IDLE state to RRC_CONNECTED state.
When the UE is about to undergo, is undergoing or has just undergone a transition from RRC_CONNECTED state to RRC_INACTIVE state.
When the UE is about to undergo, is undergoing or has just undergone a transition from RRC_CONNECTED state to RRC_IDLE state.
When the UE is in an RRC_INACTIVE or RRC_IDLE state and upon/after mobility transitions to RRC_CONNECTED, or vice versa
When the UE receives data via MBS and the MBS delivery mode is changed, e.g., from point-to-point (PTP) to point-to-multipoint (PTM) or from PTM to PTP.
When the UE has had a change of energy source.
When the UE's remaining energy, or estimated remaining on-time (based on the remaining available energy), goes below a threshold.
When the UE is in a certain cell, public land mobile network (PLMN), tracking area (TA) (or list of TAs) or at a certain geographical location, or in a certain geographical area or certain geographical areas.
When the traffic intensity for the application session in question is of certain volume. For example, when the traffic volume is low, the measurement periodicity can be higher than when the traffic volume is high.
The flexible configuration may also indicate how the measurements or reporting should be performed in relation to the application-level behavior. e.g., in DASH, the video segments are downloaded until a certain buffer occupancy is reached and is followed by a period where all downloads for that application are suspended. The configuration may suggest the UE to measure and report immediately (or with a certain periodicity) during the periods when downloads are active and store the generated QoE/RVQUE reports which are generated during the inactive periods to be transmitted in the next time the client starts downloading again.
When a metric or measured value goes above a certain threshold or goes below a certain threshold, or it is within a certain range of values, wherein such a metric or measured value e.g., may be:
   a buffer level (e.g., in a playout buffer for a streaming application),
   a playout delay, e.g., an initial playout delay or a playout delay for media startup,
   UE speed/UE velocity,
   remaining energy available to the UE,
   UE energy score
   A network energy efficiency score,
   A network energy/power saving level,
   A network energy/power consumption level,
   one or more reported QoE metrics,
   one or more reported RVQoE metrics or RVQoE values,
   remaining lifetime of a cell in a Non-Terrestrial Network (e.g., the time remaining until the time (UTC) indicated by the parameter t-Service-r17 in SIB19).

Flexible configuration can indicate one or more QoE flexibility levels, like a first QoE flexibility level, a second QoE flexibility level, and an Nth QoE flexibility level. In an example embodiment, the flexible configuration includes at least one RVQoE or QoE flexibility level.

A QoE flexibility level includes information to assist a UE in determining whether and how to alter the QoE/RVQOE measurements specified by (other) QoE/RVQUE configuration parameters and/or to determine whether and how to alter the QoE/RVQoE reporting. An example embodiment the at least one of the RVQoE or QoE flexibility level comprises information to assist the UE in determining whether and how to alter a RVQoE or QoE measurement specified by other RVQoE or QoE configuration parameters, and/or to determine whether and how to alter the RVQoE or QoE report or the timing of the RVQOE or QoE report.

In one non-limiting example of QoE flexibility level, a (first) QoE flexibility level may correspond for instance to a default QoE flexibility level (or to the strictest QoE flexibility level) where the effect is to not apply any particular change to QoE/RVQoE configuration parameters, e.g., measurement or reporting configuration parameters. In a possible implementation, the default QoE flexibility level can be associated to a value 0. When this level is communicated to a UE (in the form of a flexible configuration), the UE shall perform all QoE/RVQoE measurements as indicated in the respective QoE/RVQUE configurations, and it shall send QoE/RVQoE reports according to the specified periodicity (respectively in the XML file containing the QoE configuration or in the RVQoE configuration received by RAN); The default QoE flexibility level may be implicitly communicated to the UE, e.g., if no QoE flexibility level is sent to the UE (e.g., no explicit flexibility level indication and/or no information intended to assist the UE to determine a flexibility level), it is clear that the default QoE flexibility level shall be used.

In another non-limiting example of QoE flexibility level, other QoE flexibility levels may be used to indicate to a UE that the UE is allowed to relax the collection of QoE/RVQUE measurements and/or the sending of QoE/RVQoE reports compared to the default QoE flexibility level. Each flexibility level can be mapped to a certain criterion. For example, when the UE is in high mobility, the measurement periodicity and reporting periodicity should be smaller. In another variant, the number of samples included in the report should be higher or lower than if the UE was moving at low speed.

The characteristics of the relaxation can be signaled in various forms. For example: indicating a reduced set of QoE metrics to be measured compared to a default, an increase in the reporting period between consecutive QoE/RVQUE reports; an indication to only perform measurements for RVQUE (or to only perform QoE measurements and not RVQoE); an indication to limit the reporting only to RVQUE (or only limiting the reporting to QoE).

The relaxed QoE requirements can be associated (implicitly or explicitly) to certain RRC states. For example, a flexible configuration can pertain to a second QoE flexibility level and indicates to a UE that it is allowed to reduce the sampling rate used for the collection of QoE/RVQoE metrics (e.g., the amount of buffer level samples per second) when the UE is in RRC_INACTIVE state compared to the sampling rate used by the UE when the UE is in RRC_CONNECTED state. The same (or another) flexible configuration can also indicate the exact value or the allowed range of values for the reduction in sampling rate.

The UE can be requested by the network node providing flexible QoE and/or RVQUE configuration parameter(s) (e.g., a RAN node or an OAM node), to indicate, together with a QoE/RVQoE report, or within a QoE/RVQOE report that the QoE/RVQOE report has (or has not) been altered due to the possibilities allowed by the flexible configuration. Optionally, such an indication may also comprise, or be accompanied by, an indication of in what way the QoE/RVQoE report has been altered, e.g. which QoE metrics that have been omitted and/or which periodicities that have been changed and to what value(s). Alternatively, the UE can indicate in the QoE/RVQoE report, or together with the QoE/RVQoE report, the flexibility level that has been applied to the report, the reporting properties (e.g., periodicity) and/or the QoE/RVQUE measurements whose results populate the QoE/RVQOE report, from which the receiver of the QoE/RVQoE report and indication of applied flexibility level can deduce the resulting alteration of the QoE/RVQUE report (including reporting properties and the QoE/RVQoE measurements whose results populate the report).

The UE may also be requested (as part of the flexible QoE configuration) to indicate which flexible QoE configuration/QoE flexibility level has affected the report, in addition to other application states, as described above for the DASH example.

In one example, new indications for the handling of QoE configuration parameters are added. Currently, the network handles the area scope when the UE is in RRC_CONNECTED state and the UE is assumed to handle the area scope when the UE is in RRC_INACTIVE or RRC_IDLE state. If the QoE configurations are valid for multiple RRC states the handling of the area scope may need to be aligned or coordinated, e.g., it has to be clear which entity, the UE or the network, that is responsible for the area scope monitoring at any given time, e.g., in each RRC state. There are different options for how this may be done:
The UE may handle the area scope also in RRC_CONNECTED state. This may e.g., be achieved by sending the area scope to the UE.
The network may handle the area scope also in RRC_INACTIVE and RRC_IDLE state. This means that the UE may have to send an update to the network when it changes cell. Alternatively, the UE may be instructed to send an update to the network at some certain event, e.g., when it reselects to a certain cell.
The UE may handle the area scope in RRC_INACTIVE and RRC_IDLE state and the network in RRC_CONNECTED state. The network may in this case need to send the area scope to the UE at configuration of the flexible QoE configuration, but it needs to be clear that the area scope is valid for certain states such as e.g. RRC_INACTIVE and RRC_IDLE state only. This may be indicated explicitly or implicitly by indication or it may be stated in field descriptions or procedure text in the 3GPP RRC specification (e.g., future versions of 3GPP TS 38.331) which RRC states the area scope is applicable for in the UE.

Some embodiments for enabling the QoE measurement flexibility is enabling a UE to perform the QoE measurements independently of its RRC state. In an example embodiment, the flexible configuration enables the UE to perform the RVQUE measurement or the QoE measurement independently of a radio resource control, RRC, state of the UE. One option to enable the application layer measurements in RRC non-CONNECTED states, is to include indication in the QoE configuration to continue the QoE/RVQUE measurements when a UE enters the RRC INACTIVE or RRC IDLE state. In this case the indication of the UE's RRC state can be included in the MeasReportAppLayer, as rrcState with three values available, e.g., CONNECTED, INACTIVE, and IDLE. Another degree of QoE configuration with respect to its RRC state freedom lies within further adjusting the measurement logging and reporting conditions accordingly, to avoid UE transition to an RRC CONNECTED state just to transmit reports.

If/While a UE is in the RRC CONNECTED state:
Indicate “CONNECTED” in the QoE/RVQoE measurement report.
Perform measurements, according to the service type.
Report the QoE/RVQoE measurements according to prescribed periodicity or when certain conditions are met for event-triggered reporting (for RVQoE).

If the UE's state changes to RRC INACTIVE from RRC_CONNECTED
Indicate “INACTIVE” as the RRC state in the measurement report,
Indication to continue the measurements according to the service type
Change measuring methods/conditions:
   reduce the measurement periodicity, or
   change from periodic to event-triggered measurement, and
Change report transmission methods/conditions:
   log/collect the measurements in the buffer as long as the UE is not in RRC_CONNECTED, or
   transmit reports as SDT if the report size is smaller than the configured size for SDT report

If the UE's state changes to RRC IDLE from RRC CONNECTED or RRC_INACTIVE:
Indicate “IDLE” as the RRC state in the measurement report
Indication to continue the QoE/RVQoE measurements according to the service type
Change measuring conditions:
   change the measurement periodicity, or
   change to event-triggered reporting, and
Change reporting conditions:
   log the measurements and store in UE AS, or
   transmit the reports via SDT, if the SDT is available for RRC IDLE state

If the UE's state changes from RRC IDLE to RRC_INACTIVE:
If the session is still ongoing:
   Indicate “INACTIVE” as the RRC state in the measurement report,
   Indication to continue the QoE/RVQOE measurements according to the service type,
   Change the measuring conditions since now the reports can be sent via SDT:
      The measuring periodicity can be increased, or
      The conditions/thresholds for event-triggered reporting can also be modified.
   Change report transmission:
      Change from measurement logging to report transmission as SDT, or
      Log the measurements and store in UE AS until UE transitions to RRC_CONNECTED
If the session has stopped/service of a serviceType is no longer provided:
   Transmit the logged/stored measurement reports as SDT, or
   Keep in a UE AS until UE transitions to RRC_CONNECTED

At least RVQoE measurement reports can be forwarded to the gNB via SDT while a UE is in RRC_INACTIVE or RRC_IDLE state, to enable real time radio resource optimization.

In an example embodiment, a parameter includes a value, and the adjustment of the parameter comprises changing or selecting the value.

Some non-limiting examples of QoE/RVQoE configuration parameter flexibility are:
Change/selection of values characterizing a certain configuration property, e.g.,
   change/selection of measurement/sampling periodicity,
   change/selection of reporting periodicity,
   change/selection of the number of samples/values of a certain metric in a report.
Change of which QoE/RVQoE metrics are measured.
Change of presentation format of a measured metric in a report, e.g., whether a set of collected/measured metric samples is reported as a list of samples/values or as an average of the collected/measured samples/values.

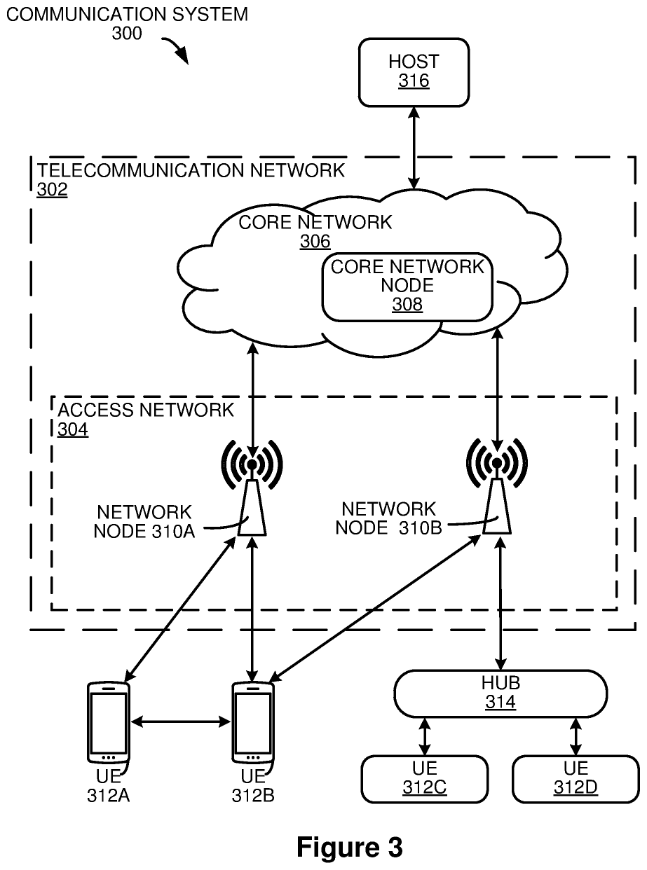

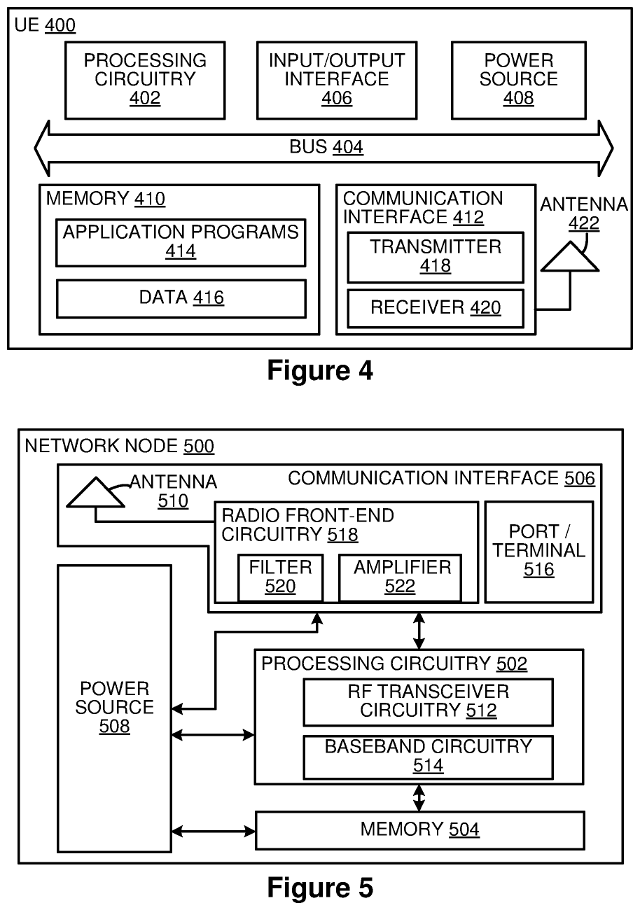

Operations of a UE can be performed by any one of the UEs 312A-312D of FIG. 3. Operations of the UE (implemented using the structure of FIG. 4) have been discussed with reference to the flow chart of FIG. 1 according to some embodiments of the present disclosure. For example, modules may be stored in memory 410 of FIG. 4, and these modules may provide instructions so that when the instructions of a module are executed by respective UE processing circuitry 402, UE 400 performs respective operations of the flow chart.

Various operations from the flow chart of FIG. 1 may be optional with respect to some embodiments of UEs and related methods. For example, the operations of blocks 102 and 104 of FIG. 1 may be optional.

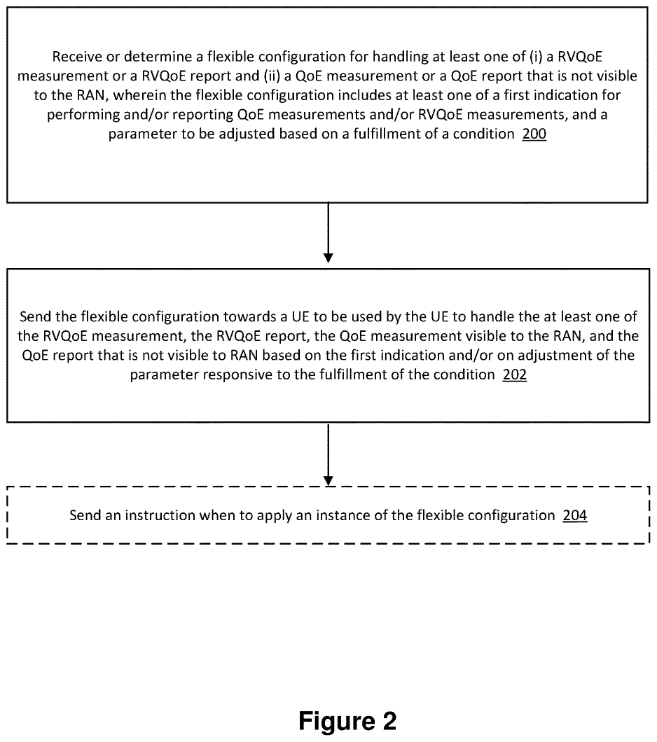

Some other embodiments are directed to a method performed by a network node (e.g., network node 310A, 310B, 308 of FIG. 3. Operations of the network node (implemented using the structure of FIG. 5) will now be discussed with reference to the flow chart of FIG. 2 according to some embodiments. For example, modules may be stored in memory 504 of FIG. 5, and these modules may provide instructions so that when the instructions of a module are executed by respective network node processing circuitry 502, network node 500 performs respective operations of the flow chart.

As illustrated in FIG. 2, a method implemented by a network node includes receiving or determining (200) a flexible configuration for handling at least one of (i) a RVQUE measurement or a RVQoE report and (ii) a QoE measurement or a QoE report that is not visible to the RAN. The flexible configuration includes a parameter to be adjusted based on a fulfillment of a condition. The method further includes sending (202) the flexible configuration towards a UE to be used by the UE to handle the at least one of the RVQoE measurement, the RVQoE report, the QoE measurement that is not visible to the RAN, and the QoE report that is not visible to RAN based on adjustment of the parameter responsive to the fulfillment of the condition.

In an example embodiment, the flexible configuration includes at least one of a configuration for a RVQoE and a configuration for a QoE that is not visible to the RAN.

An example embodiment includes a parameter that includes at least one of a sampling periodicity, a reporting periodicity, a number or samples or values of a metric in the RVQoE or QoE report, a metric to be measured, and a format of a measured metric.

An example embodiment includes a condition that includes at least one of (i) a radio resource control, RRC, state of the UE, (ii) a mobility state of the UE, (iii) a velocity and/or speed of the UE, (iv) a UE related energy score, (v) a network energy efficiency score, (vi) a network energy and/or power saving level, (vii) a network energy and/or power consumption level, and (viii) a satisfaction of at least one value of a level or a threshold for at least one reported QoE metric or for at least one reported RVQoE metric or for at least one reported RVQoE value.

In an example embodiment, the flexible configuration includes an indication to be used by the UE to determine a type and property of the QoE measurement to be performed, and/or an amount of the QoE report of the QoE measurement, and/or the RVQoE measurement to be performed, and/or an amount of the RVQoE report of the RVQoE measurement.

In an example embodiment, the receiving or the determining (operation 200 in FIG. 2) includes receiving or determining the flexible configuration in/for at least one of (i) a QoE measurement job, (ii) a QoE measurement collection configuration, (iii) a RVQoE measurement configuration sent to the network node, (iv) a RVQoE measurement configuration sent from the network node to a UE, (v) information associated to a QE measurement collection configuration, and (vi) information associated to a QoE measurement collection configuration.

In an example embodiment, the flexible configuration that is received in or determined for at least one of the QoE measurement collection configuration and/or for at least one of the RVQUE measurement collection configuration, and/or the information associated to a QoE measurement collection configuration, and/or the information associated to a RVQUE measurement collection configuration, is outside a container transparent to the RAN or within a container transparent to the RAN.

In an example embodiment, the flexible configuration includes a default configuration and the default configuration is applied when the flexible configuration is unused or deactivated.

In an example embodiment, the flexible configuration includes a plurality of parameters, and the flexible configuration is used to alter an indication conveyed in at least one of the plurality of parameters based on a criteria.

In an example embodiment, the flexible configuration comprises a value of the parameter to be selected from a range of values configured to the UE.

An example embodiment illustrated in FIG. 2 includes sending (204) an instruction when to apply an instance of the flexible configuration.

In an example embodiment, the RVQUE or QoE measurement or the RVQoE or QoE report is paused or stopped when the condition is fulfilled.

In an example embodiment, the flexible configuration includes an instruction or a condition about when the flexible configuration is applied and/or an instruction or a condition for when the flexible configuration stops being applicable.

In an example embodiment, the flexible configuration includes at least one RVQoE or QoE flexibility level.

In an example embodiment, the RVQoE or QoE flexibility level includes information to assist the UE in determining whether and how to alter a RVQoE or QoE measurement specified by other RVQoE or QoE configuration parameters, and/or to determine whether and how to alter the RVQoE or QoE report or the timing of the RVQoE or QoE report.

In an example embodiment, the flexible configuration includes the UE to perform the RVQoE or QoE measurement independently of a radio resource control, RRC, state of the UE.

In an example embodiment, a parameter includes a value, and the adjustment of the parameter comprises changing or selecting the value.

Various operations from the flow chart of FIG. 2 may be optional with respect to some embodiments of network nodes and related methods. For example, the operations of block 204 of FIG. 2 may be optional.

FIG. 3 shows an example of a communication system 300 in accordance with some embodiments.

In the example, the communication system 300 includes a telecommunication network 302 that includes an access network 304, such as a radio access network (RAN), and a core network 306, which includes one or more core network nodes 308. The access network 304 includes one or more access network nodes, such as network nodes 310a and 310b (one or more of which may be generally referred to as network nodes 310), or any other similar 3^{rd} Generation Partnership Project (3GPP) access node or non-3GPP access point. The network nodes 310 facilitate direct or indirect connection of user equipment (UE), such as by connecting UEs 312a, 312b, 312c, and 312d (one or more of which may be generally referred to as UEs 312) to the core network 306 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 300 may include any number of wired or wireless networks, network nodes, UEs, and/or any other components or systems that may facilitate or participate in the communication of data and/or signals whether via wired or wireless connections. The communication system 300 may include and/or interface with any type of communication, telecommunication, data, cellular, radio network, and/or other similar type of system.

The UEs 312 may be any of a wide variety of communication devices, including wireless devices arranged, configured, and/or operable to communicate wirelessly with the network nodes 310 and other communication devices. Similarly, the network nodes 310 are arranged, capable, configured, and/or operable to communicate directly or indirectly with the UEs 312 and/or with other network nodes or equipment in the telecommunication network 302 to enable and/or provide network access, such as wireless network access, and/or to perform other functions, such as administration in the telecommunication network 302.

In the depicted example, the core network 306 connects the network nodes 310 to one or more hosts, such as host 316. These connections may be direct or indirect via one or more intermediary networks or devices. In other examples, network nodes may be directly coupled to hosts. The core network 306 includes one more core network nodes (e.g., core network node 308) that are structured with hardware and software components. Features of these components may be substantially similar to those described with respect to the UEs, network nodes, and/or hosts, such that the descriptions thereof are generally applicable to the corresponding components of the core network node 308. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 316 may be under the ownership or control of a service provider other than an operator or provider of the access network 304 and/or the telecommunication network 302, and may be operated by the service provider or on behalf of the service provider. The host 316 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 300 of FIG. 3 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 302 is a cellular network that implements 3GPP standardized features. Accordingly, the telecommunications network 302 may support network slicing to provide different logical networks to different devices that are connected to the telecommunication network 302. For example, the telecommunications network 302 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 312 are configured to transmit and/or receive information without direct human interaction. For instance, a UE may be designed to transmit information to the access network 304 on a predetermined schedule, when triggered by an internal or external event, or in response to requests from the access network 304. Additionally, a UE may be configured for operating in single-or multi-RAT or multi-standard mode. For example, a UE may operate with any one or combination of Wi-Fi, NR (New Radio) and LTE, e.g., being configured for multi-radio dual connectivity (MR-DC), such as E-UTRAN (Evolved-UMTS Terrestrial Radio Access Network) New Radio-Dual Connectivity (EN-DC).

In the example, the hub 314 communicates with the access network 304 to facilitate indirect communication between one or more UEs (e.g., UE 312c and/or 312d) and network nodes (e.g., network node 310b). In some examples, the hub 314 may be a controller, router, content source and analytics, or any of the other communication devices described herein regarding UEs. For example, the hub 314 may be a broadband router enabling access to the core network 306 for the UEs. As another example, the hub 314 may be a controller that sends commands or instructions to one or more actuators in the UEs. Commands or instructions may be received from the UEs, network nodes 310, or by executable code, script, process, or other instructions in the hub 314. As another example, the hub 314 may be a data collector that acts as temporary storage for UE data and, in some embodiments, may perform analysis or other processing of the data. As another example, the hub 314 may be a content source. For example, for a UE that is a VR headset, display, loudspeaker or other media delivery device, the hub 314 may retrieve VR assets, video, audio, or other media or data related to sensory information via a network node, which the hub 314 then provides to the UE either directly, after performing local processing, and/or after adding additional local content. In still another example, the hub 314 acts as a proxy server or orchestrator for the UEs, in particular in if one or more of the UEs are low energy IoT devices.

The hub 314 may have a constant/persistent or intermittent connection to the network node 310b. The hub 314 may also allow for a different communication scheme and/or schedule between the hub 314 and UEs (e.g., UE 312c and/or 312d), and between the hub 314 and the core network 306. In other examples, the hub 314 is connected to the core network 306 and/or one or more UEs via a wired connection. Moreover, the hub 314 may be configured to connect to an M2M service provider over the access network 304 and/or to another UE over a direct connection. In some scenarios, UEs may establish a wireless connection with the network nodes 310 while still connected via the hub 314 via a wired or wireless connection. In some embodiments, the hub 314 may be a dedicated hub—that is, a hub whose primary function is to route communications to/from the UEs from/to the network node 310b. In other embodiments, the hub 314 may be a non-dedicated hub—that is, a device which is capable of operating to route communications between the UEs and network node 310b, but which is additionally capable of operating as a communication start and/or end point for certain data channels.

FIG. 4 shows a UE 400 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 400 includes processing circuitry 402 that is operatively coupled via a bus 404 to an input/output interface 406, a power source 408, a memory 410, a communication interface 412, and/or any other component, or any combination thereof. Certain UEs may utilize all or a subset of the components shown in FIG. 4. The level of integration between the components may vary from one UE to another UE. Further, certain UEs may contain multiple instances of a component, such as multiple processors, memories, transceivers, transmitters, receivers, etc.

The processing circuitry 402 is configured to process instructions and data and may be configured to implement any sequential state machine operative to execute instructions stored as machine-readable computer programs in the memory 410. The processing circuitry 402 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 402 may include multiple central processing units (CPUs).

In the example, the input/output interface 406 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 400. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 408 is structured as a battery or battery pack. Other types of power sources, such as an external power source (e.g., an electricity outlet), photovoltaic device, or power cell, may be used. The power source 408 may further include power circuitry for delivering power from the power source 408 itself, and/or an external power source, to the various parts of the UE 400 via input circuitry or an interface such as an electrical power cable. Delivering power may be, for example, for charging of the power source 408. Power circuitry may perform any formatting, converting, or other modification to the power from the power source 408 to make the power suitable for the respective components of the UE 400 to which power is supplied.

The memory 410 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 410 includes one or more application programs 414, such as an operating system, web browser application, a widget, gadget engine, or other application, and corresponding data 416. The memory 410 may store, for use by the UE 400, any of a variety of various operating systems or combinations of operating systems.

The memory 410 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 410 may allow the UE 400 to access instructions, application programs and the like, stored on transitory or non-transitory memory media, to off-load data, or to upload data. An article of manufacture, such as one utilizing a communication system may be tangibly embodied as or in the memory 410, which may be or comprise a device-readable storage medium.

The processing circuitry 402 may be configured to communicate with an access network or other network using the communication interface 412. The communication interface 412 may comprise one or more communication subsystems and may include or be communicatively coupled to an antenna 422. The communication interface 412 may include one or more transceivers used to communicate, such as by communicating with one or more remote transceivers of another device capable of wireless communication (e.g., another UE or a network node in an access network). Each transceiver may include a transmitter 418 and/or a receiver 420 appropriate to provide network communications (e.g., optical, electrical, frequency allocations, and so forth). Moreover, the transmitter 418 and receiver 420 may be coupled to one or more antennas (e.g., antenna 422) and may share circuit components, software or firmware, or alternatively be implemented separately.

In the illustrated embodiment, communication functions of the communication interface 412 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 412, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected, an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal-or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 400 shown in FIG. 4.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 5 shows a network node 500 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 500 includes a processing circuitry 502, a memory 504, a communication interface 506, and a power source 508. The network node 500 may be composed of multiple physically separate components (e.g., a NodeB component and a RNC component, or a BTS component and a BSC component, etc.), which may each have their own respective components. In certain scenarios in which the network node 500 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 500 may be configured to support multiple radio access technologies (RATs). In such embodiments, some components may be duplicated (e.g., separate memory 504 for different RATs) and some components may be reused (e.g., a same antenna 510 may be shared by different RATs). The network node 500 may also include multiple sets of the various illustrated components for different wireless technologies integrated into network node 500, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 500.

The processing circuitry 502 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 500 components, such as the memory 504, to provide network node 500 functionality.

In some embodiments, the processing circuitry 502 includes a system on a chip (SOC). In some embodiments, the processing circuitry 502 includes one or more of radio frequency (RF) transceiver circuitry 512 and baseband processing circuitry 514. In some embodiments, the radio frequency (RF) transceiver circuitry 512 and the baseband processing circuitry 514 may be on separate chips (or sets of chips), boards, or units, such as radio units and digital units. In alternative embodiments, part or all of RF transceiver circuitry 512 and baseband processing circuitry 514 may be on the same chip or set of chips, boards, or units.

The memory 504 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 502. The memory 504 may store any suitable instructions, data, or information, including a computer program, software, an application including one or more of logic, rules, code, tables, and/or other instructions capable of being executed by the processing circuitry 502 and utilized by the network node 500. The memory 504 may be used to store any calculations made by the processing circuitry 502 and/or any data received via the communication interface 506. In some embodiments, the processing circuitry 502 and memory 504 is integrated.

The communication interface 506 is used in wired or wireless communication of signaling and/or data between a network node, access network, and/or UE. As illustrated, the communication interface 506 comprises port(s)/terminal(s) 516 to send and receive data, for example to and from a network over a wired connection. The communication interface 506 also includes radio front-end circuitry 518 that may be coupled to, or in certain embodiments a part of, the antenna 510310. Radio front-end circuitry 518 comprises filters 520 and amplifiers 522. The radio front-end circuitry 518 may be connected to an antenna 510 and processing circuitry 502. The radio front-end circuitry may be configured to condition signals communicated between antenna 510 and processing circuitry 502. The radio front-end circuitry 518 may receive digital data that is to be sent out to other network nodes or UEs via a wireless connection. The radio front-end circuitry 518 may convert the digital data into a radio signal having the appropriate channel and bandwidth parameters using a combination of filters 520 and/or amplifiers 522. The radio signal may then be transmitted via the antenna 510. Similarly, when receiving data, the antenna 510 may collect radio signals which are then converted into digital data by the radio front-end circuitry 518. The digital data may be passed to the processing circuitry 502. In other embodiments, the communication interface may comprise different components and/or different combinations of components.

In certain alternative embodiments, the network node 500 does not include separate radio front-end circuitry 518, instead, the processing circuitry 502 includes radio front-end circuitry and is connected to the antenna 510. Similarly, in some embodiments, all or some of the RF transceiver circuitry 512 is part of the communication interface 506. In still other embodiments, the communication interface 506 includes one or more ports or terminals 516, the radio front-end circuitry 518, and the RF transceiver circuitry 512, as part of a radio unit (not shown), and the communication interface 506 communicates with the baseband processing circuitry 514, which is part of a digital unit (not shown).

The antenna 510 may include one or more antennas, or antenna arrays, configured to send and/or receive wireless signals. The antenna 510 may be coupled to the radio front-end circuitry 518 and may be any type of antenna capable of transmitting and receiving data and/or signals wirelessly. In certain embodiments, the antenna 510 is separate from the network node 500 and connectable to the network node 500 through an interface or port.

The antenna 510, communication interface 506, and/or the processing circuitry 502 may be configured to perform any receiving operations and/or certain obtaining operations described herein as being performed by the network node. Any information, data and/or signals may be received from a UE, another network node and/or any other network equipment. Similarly, the antenna 510, the communication interface 506, and/or the processing circuitry 502 may be configured to perform any transmitting operations described herein as being performed by the network node. Any information, data and/or signals may be transmitted to a UE, another network node and/or any other network equipment.

The power source 508 provides power to the various components of network node 500 in a form suitable for the respective components (e.g., at a voltage and current level needed for each respective component). The power source 508 may further comprise, or be coupled to, power management circuitry to supply the components of the network node 500 with power for performing the functionality described herein. For example, the network node 500 may be connectable to an external power source (e.g., the power grid, an electricity outlet) via an input circuitry or interface such as an electrical cable, whereby the external power source supplies power to power circuitry of the power source 508. As a further example, the power source 508 may comprise a source of power in the form of a battery or battery pack which is connected to, or integrated in, power circuitry. The battery may provide backup power should the external power source fail.

Embodiments of the network node 500 may include additional components beyond those shown in FIG. 5 for providing certain aspects of the network node's functionality, including any of the functionality described herein and/or any functionality necessary to support the subject matter described herein. For example, the network node 500 may include user interface equipment to allow input of information into the network node 500 and to allow output of information from the network node 500. This may allow a user to perform diagnostic, maintenance, repair, and other administrative functions for the network node 500.

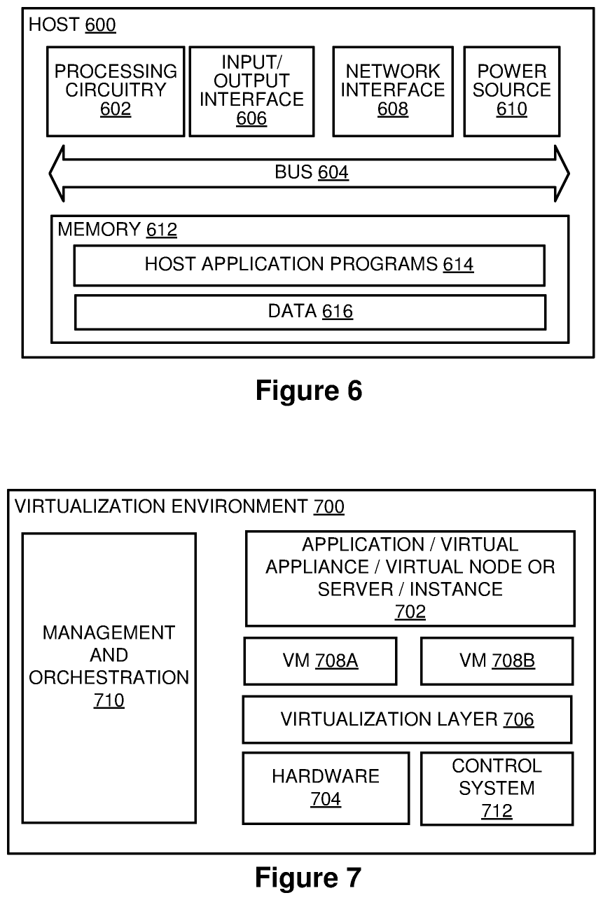

FIG. 6 is a block diagram of a host 600, which may be an embodiment of the host 316 of FIG. 3, in accordance with various aspects described herein. As used herein, the host 600 may be or comprise various combinations hardware and/or software, including a standalone server, a blade server, a cloud-implemented server, a distributed server, a virtual machine, container, or processing resources in a server farm. The host 600 may provide one or more services to one or more UEs.

The host 600 includes processing circuitry 602 that is operatively coupled via a bus 604 to an input/output interface 606, a network interface 608, a power source 610, and a memory 612. Other components may be included in other embodiments. Features of these components may be substantially similar to those described with respect to the devices of previous figures, such as FIGS. 4 and 5, such that the descriptions thereof are generally applicable to the corresponding components of host 600.

The memory 612 may include one or more computer programs including one or more host application programs 614 and data 616, which may include user data, e.g., data generated by a UE for the host 600 or data generated by the host 600 for a UE. Embodiments of the host 600 may utilize only a subset or all of the components shown. The host application programs 614 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 614 may also provide for user authentication and licensing checks and may periodically report health, routes, and content availability to a central node, such as a device in or on the edge of a core network. Accordingly, the host 600 may select and/or indicate a different host for over-the-top services for a UE. The host application programs 614 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 7 is a block diagram illustrating a virtualization environment 700 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 700 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 702 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 704 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 706 (also referred to as hypervisors or virtual machine monitors (VMMs)), provide VMs 708a and 708b (one or more of which may be generally referred to as VMs 708), and/or perform any of the functions, features and/or benefits described in relation with some embodiments described herein. The virtualization layer 706 may present a virtual operating platform that appears like networking hardware to the VMs 708.

The VMs 708 comprise virtual processing, virtual memory, virtual networking or interface and virtual storage, and may be run by a corresponding virtualization layer 706. Different embodiments of the instance of a virtual appliance 702 may be implemented on one or more of VMs 708, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 708 may be a software implementation of a physical machine that runs programs as if they were executing on a physical, non-virtualized machine. Each of the VMs 708, and that part of hardware 704 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 708 on top of the hardware 704 and corresponds to the application 702.

Hardware 704 may be implemented in a standalone network node with generic or specific components. Hardware 704 may implement some functions via virtualization. Alternatively, hardware 704 may be part of a larger cluster of hardware (e.g. such as in a data center or CPE) where many hardware nodes work together and are managed via management and orchestration 710, which, among others, oversees lifecycle management of applications 702. In some embodiments, hardware 704 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 712 which may alternatively be used for communication between hardware nodes and radio units.

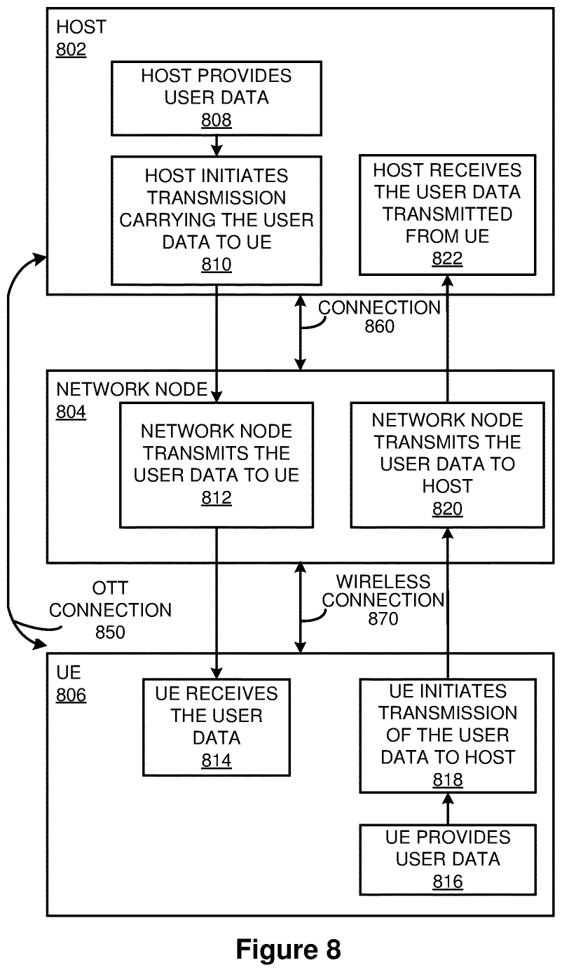

FIG. 8 shows a communication diagram of a host 802 communicating via a network node 804 with a UE 806 over a partially wireless connection in accordance with some embodiments. Example implementations, in accordance with various embodiments, of the UE (such as a UE 312a of FIG. 3 and/or UE 400 of FIG. 4), network node (such as network node 310a of FIG. 3 and/or network node 500 of FIG. 5), and host (such as host 316 of FIG. 3 and/or host 600 of FIG. 6) discussed in the preceding paragraphs will now be described with reference to FIG. 8.

Like host 600, embodiments of host 802 include hardware, such as a communication interface, processing circuitry, and memory. The host 802 also includes software, which is stored in or accessible by the host 802 and executable by the processing circuitry. The software includes a host application that may be operable to provide a service to a remote user, such as the UE 806 connecting via an over-the-top (OTT) connection 850 extending between the UE 806 and host 802. In providing the service to the remote user, a host application may provide user data which is transmitted using the OTT connection 850.

The network node 804 includes hardware enabling it to communicate with the host 802 and UE 806. The connection 860 may be direct or pass through a core network (like core network 306 of FIG. 3) and/or one or more other intermediate networks, such as one or more public, private, or hosted networks. For example, an intermediate network may be a backbone network or the Internet.

The UE 806 includes hardware and software, which is stored in or accessible by UE 806 and executable by the UE's processing circuitry. The software includes a client application, such as a web browser or operator-specific “app” that may be operable to provide a service to a human or non-human user via UE 806 with the support of the host 802. In the host 802, an executing host application may communicate with the executing client application via the OTT connection 850 terminating at the UE 806 and host 802. In providing the service to the user, the UE's client application may receive request data from the host's host application and provide user data in response to the request data. The OTT connection 850 may transfer both the request data and the user data. The UE's client application may interact with the user to generate the user data that it provides to the host application through the OTT connection 850.

The OTT connection 850 may extend via a connection 860 between the host 802 and the network node 804 and via a wireless connection 870 between the network node 804 and the UE 806 to provide the connection between the host 802 and the UE 806. The connection 860 and wireless connection 870, over which the OTT connection 850 may be provided, have been drawn abstractly to illustrate the communication between the host 802 and the UE 806 via the network node 804, without explicit reference to any intermediary devices and the precise routing of messages via these devices.

As an example of transmitting data via the OTT connection 850, in step 808, the host 802 provides user data, which may be performed by executing a host application. In some embodiments, the user data is associated with a particular human user interacting with the UE 806. In other embodiments, the user data is associated with a UE 806 that shares data with the host 802 without explicit human interaction. In step 810, the host 802 initiates a transmission carrying the user data towards the UE 806. The host 802 may initiate the transmission responsive to a request transmitted by the UE 806. The request may be caused by human interaction with the UE 806 or by operation of the client application executing on the UE 806. The transmission may pass via the network node 804, in accordance with the teachings of the embodiments described throughout this disclosure. Accordingly, in step 812, the network node 804 transmits to the UE 806 the user data that was carried in the transmission that the host 802 initiated, in accordance with the teachings of the embodiments described throughout this disclosure. In step 814, the UE 806 receives the user data carried in the transmission, which may be performed by a client application executed on the UE 806 associated with the host application executed by the host 802.

In some examples, the UE 806 executes a client application which provides user data to the host 802. The user data may be provided in reaction or response to the data received from the host 802. Accordingly, in step 816, the UE 806 may provide user data, which may be performed by executing the client application. In providing the user data, the client application may further consider user input received from the user via an input/output interface of the UE 806. Regardless of the specific manner in which the user data was provided, the UE 806 initiates, in step 818, transmission of the user data towards the host 802 via the network node 804. In step 820, in accordance with the teachings of the embodiments described throughout this disclosure, the network node 804 receives user data from the UE 806 and initiates transmission of the received user data towards the host 802. In step 822, the host 802 receives the user data carried in the transmission initiated by the UE 806.

One or more of the various embodiments improve the performance of OTT services provided to the UE 806 using the OTT connection 850, in which the wireless connection 870 forms the last segment. More precisely, the teachings of these embodiments may improve efficiency and thereby provide benefits such as adjusting measurements and recording of measurements to different network scenarios.

In an example scenario, factory status information may be collected and analyzed by the host 802. As another example, the host 802 may process audio and video data which may have been retrieved from a UE for use in creating maps. As another example, the host 802 may collect and analyze real-time data to assist in controlling vehicle congestion (e.g., controlling traffic lights). As another example, the host 802 may store surveillance video uploaded by a UE. As another example, the host 802 may store or control access to media content such as video, audio, VR or AR which it can broadcast, multicast or unicast to UEs. As other examples, the host 802 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 850 between the host 802 and UE 806, in response to variations in the measurement results. The measurement procedure and/or the network functionality for reconfiguring the OTT connection may be implemented in software and hardware of the host 802 and/or UE 806. In some embodiments, sensors (not shown) may be deployed in or in association with other devices through which the OTT connection 850 passes; the sensors may participate in the measurement procedure by supplying values of the monitored quantities exemplified above, or supplying values of other physical quantities from which software may compute or estimate the monitored quantities. The reconfiguring of the OTT connection 850 may include message format, retransmission settings, preferred routing etc.; the reconfiguring need not directly alter the operation of the network node 804. Such procedures and functionalities may be known and practiced in the art. In certain embodiments, measurements may involve proprietary UE signaling that facilitates measurements of throughput, propagation times, latency and the like, by the host 802. The measurements may be implemented in that software causes messages to be transmitted, in particular empty or ‘dummy’ messages, using the OTT connection 850 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### LISTING OF EMBODIMENTS

Embodiment 1. A method implemented in a user equipment, UE, comprising:
receiving (100) a flexible configuration for handling at least one of (i) a radio access network, RAN, visible quality of experience (RVQoE) measurement or a RVQoE report and (ii) a quality of experience (QoE) measurement or a QoE report that is not visible to the RAN, wherein the flexible configuration includes a parameter to be adjusted based on a fulfillment of a condition; and
handling (106) the at least one of the RVQoE measurement, the RVQUE report, the QoE measurement that is not visible to the RAN, and the QoE report that is not visible to RAN based on adjustment of the parameter responsive to the fulfillment of the condition.

Embodiment 2. The method of Embodiment 1, wherein the flexible configuration comprises at least one of a configuration for a radio access network, RAN, visible QoE (RVQoE) and a configuration for a QoE that is not visible to the RAN.

Embodiment 3. The method of any one of Embodiments 1 to 2, wherein the parameter comprises at least one of a sampling periodicity, a reporting periodicity, a number or samples or values of a metric in the RVQoE or QoE report, a metric to be measured, and a format of a measured metric.

Embodiment 4. The method of any one of Embodiments 1 to 3, wherein the condition comprises at least one of (i) a radio resource control, RRC, state of the UE, (ii) a mobility state of the UE, (iii) a velocity and/or speed of the UE, (iv) a UE related energy score, (v) a network energy efficiency score, (vi) a network energy and/or power saving level, (vii) a network energy and/or power consumption level, and (viii) a satisfaction of at least one value of a level or a threshold for at least one reported QoE metric or for at least one reported RVQoE metric or for at least one reported RVQoE value.

Embodiment 5. The method of any one of Embodiments 1 to 4, wherein the flexible configuration comprises an indication to be used by the UE to determine a type and property of the QoE measurement to be performed, and/or an amount of the QoE report of the QoE measurement, and/or the RVQoE measurement to be performed, and/or an amount of the RVQoE report of the RVQoE measurement.

Embodiment 6. The method of any one of Embodiments 1 to 5, wherein the receiving (100) the flexible configuration is received in at least one of (i) a QoE measurement job, (ii) a QoE measurement collection configuration received by a network node, (iii) a RVQOE measurement configuration received by a network node, (iv) information associated to a QoE measurement collection configuration received by a network node, and (vi) information associated to a RVQoE measurement collection configuration received by a network node.

Embodiment 7. The method of Embodiment 6, wherein the flexible configuration that is received in at least one of the QoE measurement collection configuration and/or for at least one of the RVQoE measurement collection configuration sent by a network node, and/or the information associated to a QoE measurement collection configuration and/or the information associated to a RVQoE measurement collection configuration, is outside a container transparent to the RAN or within a container transparent to the RAN.

Embodiment 8. The method of any one of Embodiments 1 to 7, wherein when the flexible configuration is not used or is deactivated, the UE performs the QoE measurement as indicated in a list of QoE metrics included in a QoE configuration and/or as indicated in the list of RVQoE metrics included in a RVQoE configuration.

Embodiment 9. The method of Embodiment 8, wherein when the flexible configuration comprises a periodicity for the RVQoE or QoE report, the handling (106) is performed at the periodicity.

Embodiment 10. The method of any one of Embodiments 1 to 9, wherein when the QoE configuration comprises a periodicity for the QoE report, the UE handles the QoE measurement or the QoE report of a QE measurement at the periodicity.

Embodiment 11. The method of any one of Embodiments 1 to 7, wherein the flexible configuration comprises a default configuration and the default configuration is applied when the flexible configuration is unused or deactivated.

Embodiment 12. The method of any one of Embodiments 1 to 11, wherein the flexible configuration comprises a plurality of parameters, and the flexible configuration is used to alter an indication conveyed in at least one of the plurality of parameters based on a criteria.
Embodiment 13. The method of Embodiment 12, further comprising:
selecting (102) a value of the parameter from a range of values configured to the UE.

Embodiment 14. The method of any one of Embodiments 1 to 13, further comprising:
receiving (104) an instruction when to apply an instance of the flexible configuration.

Embodiment 15. The method of any one of Embodiments 1 to 14, further comprising:
pausing or stopping at least one of a RVQoE measurement, a QoE measurement, the RVQoE report, or the QoE report when the condition is fulfilled.

Embodiment 16. The method of any one of Embodiments 1 to 15, wherein the flexible configuration comprises an instruction or a condition about when the flexible configuration is applied and/or an instruction or a condition for when the flexible configuration stops being applicable.

Embodiment 17. The method of any one of Embodiments 1 to 16, wherein the flexible configuration comprises at least one RVQoE or QoE flexibility level.

Embodiment 18. The method of Embodiment 17, wherein the at least one of the RVQoE or QoE flexibility level comprises information to assist the UE in determining whether and how to alter a RVQoE or QoE measurement specified by other RVQoE or QoE configuration parameters, and/or to determine whether and how to alter the RVQoE or QoE report or the timing of the RVQoE or QoE report.

Embodiment 19. The method of any one of Embodiments 1 to 18, wherein the flexible configuration enables the UE to perform the RVQoE measurement or the QoE measurement independently of a radio resource control, RRC, state of the UE.

Embodiment 20. The method of any one of Embodiments 1 to 19, wherein the parameter comprises a value, and the adjustment of the parameter comprises changing or selecting the value.

Embodiment 21. A method implemented in a network node, comprising:
receiving or determining (200) a flexible configuration for handling at least one of (i) a radio access network, RAN, visible quality of experience (RVQoE) measurement or a RVQUE report and (ii) a quality of experience (QoE) measurement or a QoE report that is not visible to the RAN, wherein the flexible configuration includes a parameter to be adjusted based on a fulfillment of a condition; and
sending (202) the flexible configuration towards a user equipment, UE, to be used by the UE to handle the at least one of the RVQoE measurement, the RVQoE report, the QoE measurement that is not visible to the RAN, and the QoE report that is not visible to RAN based on adjustment of the parameter responsive to the fulfillment of the condition.

Embodiment 22. The method of Embodiment 21, wherein the flexible configuration comprises at least one of a configuration for a radio access network, RAN, visible QoE (RVQoE) and a configuration for a QoE that is not visible to the RAN.

Embodiment 23. The method of any one of Embodiments 20 to 21, wherein the parameter comprises at least one of a sampling periodicity, a reporting periodicity, a number or samples or values of a metric in the RVQoE or QoE report, a metric to be measured, and a format of a measured metric.

Embodiment 24. The method of any one of Embodiments 20 to 23, wherein the condition comprises at least one of (i) a radio resource control, RRC, state of the UE, (ii) a mobility state of the UE, (iii) a velocity and/or speed of the UE, (iv) a UE related energy score, (v) a network energy efficiency score, (vi) a network energy and/or power saving level, (vii) a network energy and/or power consumption level, and (viii) a satisfaction of at least one value of a level or a threshold for at least one reported QoE metric or for at least one reported RVQUE metric or for at least one reported RVQoE value.

Embodiment 25. The method of any one of Embodiments 20 to 24, wherein the flexible configuration comprises an indication to be used by the UE to determine a type and property of the QoE measurement to be performed, and/or an amount of the QoE report of the QoE measurement, and/or the RVQoE measurement to be performed, and/or an amount of the RVQoE report of the RVQoE measurement.

Embodiment 26. The method of any one of Embodiments 20 to 25, wherein the receiving or the determining (200) comprises receiving or determining the flexible configuration in/for at least one of (i) a QoE measurement job, (ii) a QoE measurement collection configuration, (iii) a RVQoE measurement configuration sent to the network node, (iv) a RVQUE measurement configuration sent from the network node to a UE, (v) information associated to a QoE measurement collection configuration, and (vi) information associated to a QoE measurement collection configuration.

Embodiment 27. The method of Embodiment 26, wherein the flexible configuration that is received in or determined for at least one of the QoE measurement collection configuration and/or for at least one of the RVQoE measurement collection configuration, and/or the information associated to a QoE measurement collection configuration, and/or the information associated to a RVQoE measurement collection configuration, is outside a container transparent to the RAN or within a container transparent to the RAN.

Embodiment 28. The method of any one of Embodiments 21 to 27, wherein the flexible configuration comprises a default configuration and the default configuration is applied when the flexible configuration is unused or deactivated.

Embodiment 29. The method of any one of Embodiments 21 to 28, wherein the flexible configuration comprises a plurality of parameters, and the flexible configuration is used to alter an indication conveyed in at least one of the plurality of parameters based on a criteria.

Embodiment 30. The method of any one of Embodiments 21 to 29, wherein the flexible configuration comprises a value of the parameter to be selected from a range of values configured to the UE.

Embodiment 31. The method of any one of Embodiments 21 to 30, further comprising:
sending (204) an instruction when to apply an instance of the flexible configuration.

Embodiment 32. The method of any one of Embodiments 21 to 31, wherein the RVQoE or QoE measurement or the RVQoE or QoE report is paused or stopped when the condition is fulfilled.

Embodiment 33. The method of any one of Embodiments 21 to 32, wherein the flexible configuration comprises an instruction or a condition about when the flexible configuration is applied and/or an instruction or a condition for when the flexible configuration stops being applicable.

Embodiment 34. The method of any one of Embodiments 21 to 33, wherein the flexible configuration comprises at least one RVQoE or QoE flexibility level.

Embodiment 35. The method of Embodiment 34, wherein the RVQoE or QoE flexibility level comprises information to assist the UE in determining whether and how to alter a RVQOE or QoE measurement specified by other RVQoE or QoE configuration parameters, and/or to determine whether and how to alter the RVQoE or QoE report or the timing of the RVQoE or QoE report.

Embodiment 36. The method of any one of Embodiments 21 to 35, wherein the flexible configuration enables the UE to perform the RVQoE or QoE measurement independently of a radio resource control, RRC, state of the UE.

Embodiment 37. The method of any one of Embodiments 21 to 36, wherein the parameter comprises a value, and the adjustment of the parameter comprises changing or selecting the value.

Embodiment 38. A user equipment, UE, (312A-312D) configured to communicate with a network node, the UE comprising a radio interface and processing circuitry (402) configured to:
receive a flexible configuration for handling at least one of (i) a radio access network, RAN, visible quality of experience (RVQoE) measurement or a RVQUE report and (ii) a quality of experience (QoE) measurement or a QoE report that is not visible to the RAN, wherein the flexible configuration includes a parameter to be adjusted based on a fulfillment of a condition; and
handle the at least one of the RVQoE measurement, the RVQUE report, the QoE measurement that is not visible to the RAN, and the QoE report that is not visible to RAN based on adjustment of the parameter responsive to the fulfillment of the condition.

Embodiment 39. The UE of Embodiment 38, wherein the processing circuitry (402) is further configured to perform the method of any of Embodiments 2 to 20.

Embodiment 40. A method implemented by a host operating in a communication system that further includes a network node and a user equipment, UE, the method comprising:
providing user data for the UE; and
initiating a transmission carrying the user data to the UE via a cellular network comprising the network node, wherein the UE performs the following operations to receive the user data from the host:
receiving (100) a flexible configuration for handling at least one of (i) a radio access network, RAN, visible quality of experience (RVQoE) measurement or a RVQoE report and (ii) a quality of experience (QoE) measurement or a QoE report that is not visible to the RAN, wherein the flexible configuration includes a parameter to be adjusted based on a fulfillment of a condition; and
handling (106) the at least one of the RVQUE measurement, the RVQoE report, the QoE measurement that is not visible to the RAN, and the QoE report that is not visible to RAN based on adjustment of the parameter responsive to the fulfillment of the condition.

Embodiment 41. The method of Embodiment 40 further comprising:
performing the method of any of Embodiments 2 to 20.

Embodiment 42. A host configured to operate in a communication system to provide over-the-top, OTT, service, the host comprising:
processing circuitry configured to provide user data; and
a network interface configured to initiate transmission of the user data to a cellular network for transmission to a user equipment, UE, wherein the UE comprises a communication interface and processing circuitry, the communication interface and processing circuitry of the UE being configured to perform the following operations to receive the user data from the host:
receive a flexible configuration for handling at least one of (i) a radio access network, RAN, visible quality of experience (RVQoE) measurement or a RVQoE report and (ii) a quality of experience (QoE) measurement or a QoE report that is not visible to the RAN, wherein the flexible configuration includes a parameter to be adjusted based on a fulfillment of a condition; and
handle the at least one of the RVQoE measurement, the RVQUE report, the QoE measurement that is not visible to the RAN, and the QoE report that is not visible to RAN based on adjustment of the parameter responsive to the fulfillment of the condition.

Embodiment 43. The method of Embodiment 42, wherein the processing circuitry of the UE is further configured to perform the method of any one of Embodiments 2 to 20.

Embodiment 44. A network node (310A, 310B, 308) configured to communicate with a plurality of user equipments, UEs, the network node comprising processing circuitry (502302) configured to:
receive or determine a flexible configuration for handling at least one of (i) a radio access network, RAN, visible quality of experience (RVQoE) measurement or a RVQoE report and (ii) a quality of experience (QoE) measurement or a QoE report that is not visible to the RAN, wherein the flexible configuration includes a parameter to be adjusted based on a fulfillment of a condition; and
send the flexible configuration towards a user equipment, UE, to be used by the UE to handle the at least one of the RVQoE measurement, the RVQoE report, the QoE measurement that is not visible to the RAN, and the QoE report that is not visible to RAN based on adjustment of the parameter responsive to the fulfillment of the condition.

Embodiment 45. The network node of Embodiment 44, wherein the processing circuitry of the network node is further configured to perform the method of any of Embodiments 22 to 37.

Embodiment 46. A method implemented by a host configured to operate in a communication system that further includes a network node and a plurality of user equipments, UEs, the method comprising:
providing user data for the UEs; and
initiating transmissions carrying the user data to the UEs via a cellular network comprising the network node, wherein the network node performs the following operations to transmit the user data from the host to the UEs:
receiving or determining (200) a flexible configuration for handling at least one of (i) a radio access network, RAN, visible quality of experience (RVQoE) measurement or a RVQUE report and (ii) a quality of experience (QoE) measurement or a QoE report that is not visible to the RAN, wherein the flexible configuration includes a parameter to be adjusted based on a fulfillment of a condition; and
send the flexible configuration towards a user equipment, UE, to be used by the UE to handle the at least one of the RVQoE measurement, the RVQoE report, the QoE measurement that is not visible to the RAN, and the QoE report that is not visible to RAN based on adjustment of the parameter responsive to the fulfillment of the condition.

Embodiment 47. The method of Embodiment 46, wherein the network node is further configured to:
perform the method of any one of Embodiments 22 to 37.

Embodiment 48. A host configured to operate in a communication system to provide an over-the-top, OTT, service, the host comprising:
processing circuitry configured to provide user data; and
a network interface configured to initiate transmissions of the user data to a network node in a cellular network for transmission to user equipments, UEs, the network node having a communication interface and processing circuitry, the processing circuitry of the network node configured to perform the following operations to transmit the user data from the host to the UEs:
receive or determine a flexible configuration for handling at least one of (i) a radio access network, RAN, visible quality of experience (RVQoE) measurement or a RVQoE report and (ii) a quality of experience (QoE) measurement or a QoE report that is not visible to the RAN, wherein the flexible configuration includes a parameter to be adjusted based on a fulfillment of a condition; and
send the flexible configuration towards a user equipment, UE, to be used by the UE to handle the at least one of the RVQoE measurement, the RVQoE report, the QoE measurement that is not visible to the RAN, and the QoE report that is not visible to RAN based on adjustment of the parameter responsive to the fulfillment of the condition.

Embodiment 49. The host of Embodiment 48, wherein the processing circuitry of the network node is further configured to:
perform the method of any one of Embodiments 22 to 37.

1. A method implemented in a user equipment, UE, comprising:
receiving a flexible configuration for handling at least one of (i) a radio access network (RAN) visible quality of experience (RVQoE) measurement or a RVQoE report and (ii) a quality of experience (QoE) measurement or a QoE report that is not visible to the RAN, wherein the flexible configuration includes at least one of
a first indication for performing and/or reporting QoE measurements and/or RVQUE measurements, and
a parameter to be adjusted based on a fulfillment of a condition; and
handling the at least one of the RVQoE measurement, the RVQoE report, the QoE measurement visible to the RAN, and the QoE report that is not visible to RAN based on the first indication and/or on adjustment of the parameter responsive to the fulfillment of the condition.

2. The method of claim 1, wherein the flexible configuration comprises at least one of a configuration for the RAN visible QoE (RVQoE) and a configuration for a QoE that is not visible to the RAN.

3. The method claim 1, wherein the first indication is to be used by the UE to determine at least one of a type of QoE measurement to be performed, a property of QoE measurements to be performed, a type of RVQoE measurements to be performed, a property of RVQoE measurements to be performed, an amount of QoE reports, and an amount of RVQoE reports.

4. The method of claim 1, wherein the parameter comprises at least one of a sampling periodicity, a reporting periodicity, a number or samples or values of a metric in the RVQoE or QoE report, a metric to be measured, and a format of a measured metric.

5. The method of claim 1, wherein the condition comprises at least one of (i) a radio resource control (RRC) state of the UE, (ii) a mobility state of the UE, (iii) a velocity and/or speed of the UE, (iv) a UE related energy score, (v) a network energy efficiency score, (vi) a network energy and/or power saving level, (vii) a network energy and/or power consumption level, and (viii) a satisfaction of at least one value of a level or a threshold for at least one reported QoE metric or for at least one reported RVQoE metric or for at least one reported RVQoE value.

6. The method of claim 1, wherein the receiving the flexible configuration is received in at least one of (i) a QoE measurement job, (ii) a QoE measurement collection configuration received by a network node, (iii) a RVQUE measurement configuration received by a network node, (iv) information associated to a QoE measurement collection configuration received by a network node, and (vi) information associated to a RVQoE measurement collection configuration received by a network node.

7. The method of claim 6, wherein the flexible configuration that is received in at least one of the QoE measurement collection configuration and/or for at least one of the RVQUE measurement collection configuration sent by a network node, and/or the information associated to a QoE measurement collection configuration and/or the information associated to a RVQUE measurement collection configuration, is outside a container transparent to the RAN or within a container transparent to the RAN.

8. The method of claim 1, wherein when the flexible configuration is not used or is deactivated, the UE performs the QoE measurement as indicated in a list of QoE metrics included in a QoE configuration and/or as indicated in the list of RVQoE metrics included in a RVQoE configuration.

9. The method of claim 8, wherein when the flexible configuration comprises a periodicity for the RVQoE or QoE report, the handling is performed at the periodicity.

10. The method of claim 1, wherein when the QoE configuration comprises a periodicity for the QoE report, the UE handles the QoE measurement or the QoE report of a QoE measurement at the periodicity.

11. The method of claim 1, wherein the flexible configuration comprises a default configuration and the default configuration is applied when the flexible configuration is unused or deactivated.

12. The method of claim 1, wherein the flexible configuration comprises a plurality of parameters, and the flexible configuration is used to alter an indication conveyed in at least one of the plurality of parameters based on a criteria.

13. The method of claim 12, further comprising:
selecting a value of the parameter from a range of values configured to the UE.

14. The method of claim 1, further comprising:
receiving an instruction when to apply an instance of the flexible configuration.

15-18. (canceled)

19. The method of claim 1, wherein the flexible configuration enables the UE to perform the RVQoE measurement or the QoE measurement independently of a radio resource control, RRC, state of the UE.

20. (canceled)

21. A method implemented in a network node, comprising:
receiving or determining a flexible configuration for handling at least one of (i) a radio access network (RAN) visible quality of experience (RVQoE) measurement or a RVQoE report and (ii) a quality of experience (QoE) measurement or a QE report that is not visible to the RAN, wherein the flexible configuration includes at least one of
a first indication for performing and/or reporting QoE measurements and/or RVQOE measurements, and
a parameter to be adjusted based on a fulfillment of a condition; and
sending the flexible configuration towards a user equipment, UE, to be used by the UE to handle the at least one of the RVQoE measurement, the RVQoE report, the QoE measurement that is not visible to the RAN, and the QoE report that is not visible to RAN based on the first indication and/or adjustment of the parameter responsive to the fulfillment of the condition.

22. The method of claim 21, wherein the flexible configuration comprises at least one of a configuration for the RAN visible QoE (RVQoE) and a configuration for a QoE that is not visible to the RAN.

23. The method of claim 21, wherein the first indication is to be used by the UE to determine at least one of a type of QoE measurement to be performed, a property of QoE measurements to be performed, a type of RVQoE measurements to be performed, a property of RVQoE measurements to be performed, an amount of QoE reports, and an amount of RVQoE reports.

24-37. (canceled)

38. A user equipment (UE) configured to communicate with a network node, the UE comprising a radio interface and processing circuitry configured to:
receive a flexible configuration for handling at least one of (i) a radio access network, RAN, visible quality of experience (RVQoE) measurement or a RVQoE report and (ii) a quality of experience (QoE) measurement or a QoE report that is not visible to the RAN, wherein the flexible configuration includes configuration includes at least one of a first indication for performing and/or reporting QoE measurements and/or RVQoE measurements, and a parameter to be adjusted based on a fulfillment of a condition; and
handle the at least one of the RVQoE measurement, the RVQoE report, the QoE measurement visible to the RAN, and the QoE report that is not visible to RAN based on the first indication and/or on adjustment of the parameter responsive to the fulfillment of the condition.

39-43. (canceled)

44. A network node configured to communicate with a plurality of user equipments (UEs), the network node comprising processing circuitry configured to:
receive or determine a flexible configuration for handling at least one of (i) a radio access network, RAN, visible quality of experience (RVQoE) measurement or a RVQoE report and (ii) a quality of experience (QoE) measurement or a QoE report that is not visible to the RAN, wherein the flexible configuration includes at least one of a first indication for performing and/or reporting QoE measurements and/or RVQoE measurements, and a parameter to be adjusted based on a fulfillment of a condition; and
send the flexible configuration towards a user equipment, UE, to be used by the UE to handle the at least one of the RVQE measurement, the RVQoE report, the QoE measurement visible to the RAN, and the QoE report that is not visible to RAN based on the first indication and/or on adjustment of the parameter responsive to the fulfillment of the condition.

45-49. (canceled)
